(19) United States
(12) Patent Application Publication
(10) Pub. No.: US 2025/0005343 A1
(43) Pub. Date: Jan. 2, 2025

(54) SYSTEM AND METHOD FOR ADAPTING A NEURAL NETWORK MODEL ON A HARDWARE PLATFORM

(71) Applicant: Tesla, Inc., Austin, TX (US)

(72) Inventor: Michael Driscoll, Mountain View, CA (US)

(21) Appl. No.: 18/886,803

(22) Filed: Sep. 16, 2024

Related U.S. Application Data
(63) Continuation of application No. 18/185,142, filed on Mar. 16, 2023, now Pat. No. 12,136,030.
Application No. 18/185,142 is a continuation of application No. 16/728,884, filed on Dec. 27, 2019, now Pat. No. 11,610,117.
(60) Provisional application No. 62/785,363, filed on Dec. 27, 2018.
(60) Provisional application No. 62/791,220, filed on Jan. 11, 2019.

(51) Int. Cl. G06N 3/063; G06F 17/16; G06F 18/20; G06F 18/21; G06N 3/08

(52) U.S. Cl. CPC G06N 3/063; G06F 17/16; G06F 18/217; G06F 18/29; G06N 3/08

(57) ABSTRACT

Systems and methods for adapting a neural network model on a hardware platform. An example method includes obtaining neural network model information comprising decision points associated with a neural network, with one or more first decision points being associated with a layout of the neural network. Platform information associated with a hardware platform for which the neural network model information is to be adapted is accessed. Constraints associated with adapting the neural network model information to the hardware platform are determined based on the platform information, with a first constraint being associated with a processing resource of the hardware platform and with a second constraint being associated with a performance metric. A candidate configuration for the neural network is generated via execution of a satisfiability solver based on the constraints, with the candidate configuration assigns values to the plurality of decision points.

### CROSS REFERENCE TO RELATED APPLICATIONS

This application is a continuation of U.S. patent application Ser. No. 18/185,142, filed Mar. 16, 2023, which is a continuation of U.S. patent application Ser. No. 16/728,884, filed Dec. 27, 2019, which claims the benefit of U.S. Provisional Patent Application No. 62/791,220, filed Jan. 11, 2019, which claims the benefit of U.S. Provisional Patent Application No. 62/785,363, filed Dec. 27, 2018, each of which is incorporated by reference herein in its entirety.

### BACKGROUND

### Technical Field

This specification relates generally to the machine learning field, and more specifically to a new and useful system and method for adapting a neural network model on a platform.

### Description of the Related Art

Neural networks are being increasingly relied upon for disparate problems due to, as an example, the ease at which they can label, or otherwise classify, input data. For example, a neural network may be used to assign an object label to a portion of an input image. An example portion of an input image may depict a person and a neural network may therefore assign a ‘person’ label to this example portion. A neural network may be defined, at least in part, by different combinations of hyperparameters and parameters. Example hyperparameters may include a number of layers, activation functions, number of neurons per layer, techniques for training a neural network, and so on. Example parameters may include information learned during training, such as values of weights, biases, and so on. Commonly, different neural networks with differing hyperparameters are trained. These different neural networks are then used to analyze the same validation training set and a particular neural network is selected for future use based on the desired performance or accuracy goals of the particular application.

For machine learning applications, it may often be desirable to implement and/or configure neural networks on previously-unimplemented platforms (e.g., software/hardware combination). However, implementing or configuring a neural network for a given platform and/or application (e.g., a use case) can be extremely difficult, because different neural networks, hardware components, software, and/or applications may have different requirements which impose complex constraints on the configuration. For example, autonomous vehicles may be constrained to implement neural networks for their artificial intelligence systems using a relatively limited set of hardware implemented in the vehicle itself, which may lead to hardware platform constraints in terms of implementation and performance. Increasingly, there is also a demand for machine learning and deep learning on mobile devices such as smart phones and tablets. In order to enable deep learning and other processing-heavy and computationally intensive techniques, the neural network model used must be adapted to generate configurations that satisfy all constraints of the platform in question.

This satisfiability problem can be complex and require a significant amount of time, energy, and resources to explore manually by a developer or administrator of the system implementing the neural network model. For example, there may be many “decision points” at which a choice must be made from many options for each configuration variable, which may drastically increase the number of potential configurations usable for a given platform. There are many decisions to make about which algorithms to implement, which data layout to implement, which of many options to select for each decision point, and more. All of these decisions have an impact on whether the neural network will run on the platform, the network performance (e.g., evaluation time, memory usage, power usage, etc.), the accuracy and performance of the neural network model, or other neural network metrics. In addition, a decision at any given decision point in this process may often cause the configuration to be invalid, given other constraints imposed at other decision points, and determining this satisfiability or unsatisfiability requires research and calculation. For example, using a deep learning library or software development kit (SDK) such as NVIDIA's CUDA Deep Neural Network library (cuDNN) requires manually consulting the documentation at every decision point to explore the implications of each option at a decision point.

### SUMMARY

One embodiment is a method implemented by a system of one or more processors. The method may include: obtaining neural network model information comprising a plurality of decision points associated with a neural network, wherein one or more first decision points are associated with a layout of the neural network; accessing platform information associated with a hardware platform for which the neural network model information is to be adapted; determining, based on the platform information, constraints associated with adapting the neural network model information to the hardware platform, wherein a first constraint is associated with a processing resource of the hardware platform and wherein a second constraint is associated with a performance metric; and generating a candidate configuration for the neural network via execution of a satisfiability solver based on the constraints, wherein the candidate configuration assigns values to the plurality of decision points.

Another embodiment is a system comprising one or more processors and non-transitory computer storage media storing instructions that when executed by the one or more processors, cause the one or more processors to perform operations including: obtaining neural network model information comprising a plurality of decision points associated with a neural network, wherein one or more first decision points are associated with a layout of the neural network; accessing platform information associated with a hardware platform for which the neural network model information is to be adapted; determining, based on the platform information, constraints associated with adapting the neural network model information to the hardware platform, wherein a first constraint is associated with a processing resource of the hardware platform and wherein a second constraint is associated with a performance metric; and generating a candidate configuration for the neural network via execution of a satisfiability solver based on the constraints, wherein the candidate configuration assigns values to the plurality of decision points.

Yet another embodiment is a non-transitory computer storage media storing instructions that when executed by a system of one or more processors, cause the one or more processors to perform operations including: obtaining neural network model information comprising a plurality of decision points associated with a neural network, wherein one or more first decision points are associated with a layout of the neural network; accessing platform information associated with a hardware platform for which the neural network model information is to be adapted; determining, based on the platform information, constraints associated with adapting the neural network model information to the hardware platform, wherein a first constraint is associated with a processing resource of the hardware platform and wherein a second constraint is associated with a performance metric; and generating a candidate configuration for the neural network via execution of a satisfiability solver based on the constraints, wherein the candidate configuration assigns values to the plurality of decision points.

### BRIEF DESCRIPTION OF THE DRAWINGS

FIG. 1 is a schematic representation of an example model configuration system.

FIG. 2 is a flowchart representation of an example model configuration method.

### DETAILED DESCRIPTION OF THE PREFERRED EMBODIMENT

The following description of the embodiments of the disclosed technology is not intended to limit the disclosed technology to these particular embodiments, but rather to enable any person skilled in the art to make and use the disclosed technology.

Although embodiments described throughout generally relate to systems and methods for neural network model adaption and configuration, it will be appreciated by those skilled in the art that the systems and methods described can be implemented and/or adapted for a variety of purposes within the machine learning and/or deep learning fields or for neural networks generally.

### Introduction

In an embodiment, techniques, systems, and methods, are described to determine a neural network configuration which is adapted to a specific platform. An example platform may represent a processing architecture, an amount of memory, and so on as described herein. Additionally, a platform may represent a particular cloud or virtual machine architecture or instance. It may be appreciated that different platforms may complicate the implementation of a neural network. For example, a certain graphics processing unit architecture may allow for specific instructions to be executed. In this example, a neural network configuration may be determined which leverages these instructions. As another example, a certain lower-powered processing architecture may have limited memory. In this example, a neural network configuration may be determined which is able to work within this limited memory.

As will be described, satisfiability techniques (e.g., constraint satisfaction techniques) may be used to determine a configuration of a neural network based on received input information associated with a hardware or software platform. Example input information may include different configurations, decision points, platform information, and so on. Advantageously, example solvers may be employed to rapidly determine the configuration of the current platform. An example solver may be a satisfiability modulo theories (SMT) solver. This example solver may use techniques, such as Davis-Putnam-Logemann-Loveland (DPLL) algorithms, Boolean Satisfiability Problem (SAT) techniques, Shostak's method, Nelsen-Oppen approaches, and/or combinations thereof. In this way, a neural network may be rapidly adapted to different platforms.

### Overview

One embodiment of a system and method includes: using a constraint satisfaction method to determine a set of candidate configurations, based on a neural network (e.g., a representation thereof), a set of possible choices at each decision point, and a set of constraints (e.g., for a platform, the network, the use case, user-imposed, etc.). In variants, the system and method for model adaption and configuration can include: traversing the neural network to identify one or more decision points, each represented by a “configuration variable” requiring a valid value; identifying one or more constraints between/among variables specified by the hardware platform for each of the variables of the decision points; identifying one or more model constraints specified by the hardware platform for the neural network model; identifying one or more performance constraints for operating the neural network model on the hardware platform; executing a satisfiability modulo theories (SMT) solver for the neural network model, wherein the variable constraints, model constraints, and performance constraints are inputs for the SMT solver; receiving one or more candidate configurations from the SMT solver; for each of the received candidate configurations, determining that the candidate configuration is satisfiable; and determining a configuration from a number of received candidate configurations that satisfies target performance metrics.

The system and method function to traverse the neural network model, determine configuration variables (and/or decision points) and network constraints; to identify valid candidate configurations using a constraint satisfaction solver (e.g., an SMT solver, a SAT solver, etc.), given a set of auxiliary constraints; and optionally to select a configuration or configurations that satisfy one or more target performance metrics. Generating a functionally correct, valid implementation of a neural network, such as a deep neural network (DNN) can be a primary aim as a result. Additionally or alternatively, the system and method can output a platform selection (e.g., a hardware selection, a software selection), a neural network selection (e.g., select the neural network to use from a set of candidate networks), or determine any other suitable parameter.

In order to produce a concrete implementation of an abstract neural network, a number of implementation decisions about one or more of system's data layout, numerical precision, algorithm selection, data padding, accelerator use, stride, and more may be made. These decisions may be made on a per-layer or per-tensor basis, so there can potentially be hundreds of decisions, or more, to make for a particular network. Embodiments of the invention take many factors into account before implementing the neural network because many configurations are not supported by underlying software or hardware platforms, and such configurations will result in an inoperable implementation.

As an illustration of one potential challenge, configuring a convolution layer using the NVIDIA CUDA® Deep Neural Network library (cuDNN) (NVIDIA Corporation), which is a library of primitives for deep neural networks, may include the following decisions:
Input tensor: datatype (2+ options), layout (2+ options), padding (4 options).
Output tensor: datatype, layout, padding.
Filter: datatype, layout, padding.
Algorithm: 10 options.
Precision: 2 options (16-bit or 32-bit floating point arithmetic).

Hardware: 2 options (CUDA cores or tensor cores).

Although this example of a convolution presents a large space of possible configurations, many configurations are invalid because they are not implemented by the neural network software development kit (SDK), such as cuDNN and/or constituent layers. Furthermore, the validity of many configurations depends on the convolution parameters; some convolution algorithms don't support certain convolution types or methods (e.g., strided convolutions), and some hardware platforms require specific sizes of tensors. The problem is even more challenging in a convolutional network, where choices have implications across neighbors. For example, the layout of a producer's output tensor should match the layout of a consumer's input tensor.

The systems and methods described herein seek to select a neural network model configuration that satisfies all constraints by, in one embodiment, enumerating a list of valid configurations by casting the configuration problem as a satisfiability problem, and using a constraint satisfaction solver (e.g., an SMT solver) to identify valid configurations for the particular platform where the neural network will run.

All or portions of the method can be performed at a predetermined frequency, performed upon occurrence of an execution event or triggering condition, or performed at any suitable time.

### System

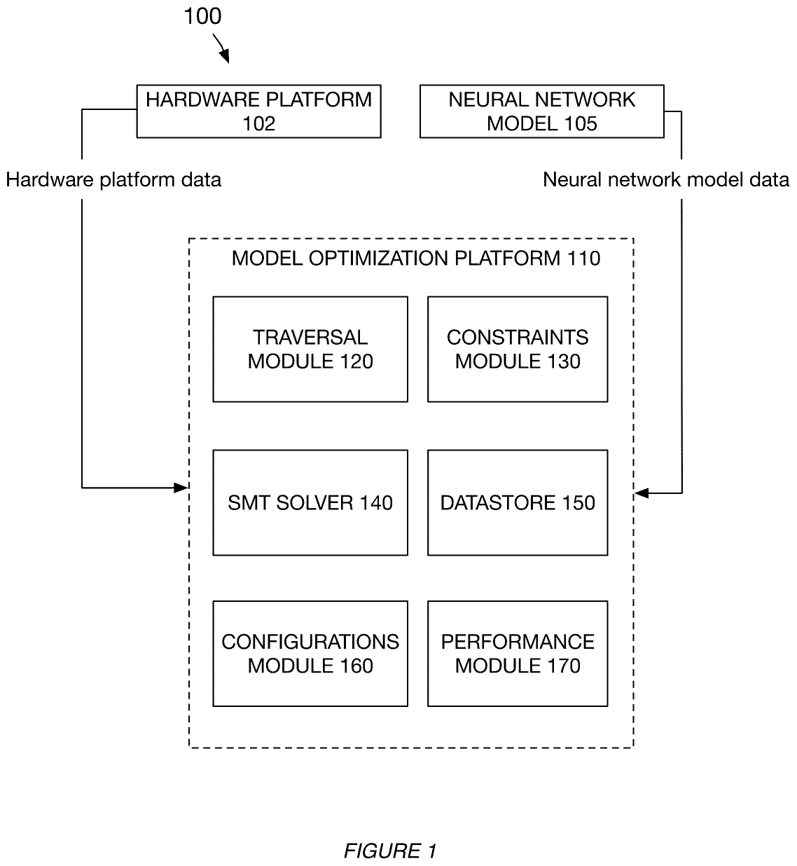

As shown in FIG. 1, the model configuration system 100 can include: a hardware platform 102, a neural network model 105, a model configuration platform 110, a traversal module 120, a constraints module 130, a constraint satisfaction solver 140 (e.g., SMT solver 140), a datastore 150, a configurations module 160, and a performance module 170.

All or portions of the system 100 can be implemented in: a local computing system, a remote computing system (e.g., cloud computing system, AWS, and so on), or at any other suitable computing location. The remote computing system can belong to or be maintained by an entity or organization, an individual, a third-party system, or any other suitable user or operator of a computing system. The system 100 may represent a system of one or more processors, one or more computers, one or more virtual machines executing on one or more computers, and so on.

In variants, the model configuration platform 110 functions to facilitate communication between various components of the system (e.g., between the neural network model and the datastore, the hardware platform and the constraints module, etc.), but can additionally or alternatively perform any other suitable functionality. The model configuration platform can additionally or alternatively host or execute the other components of the system (e.g., the neural network model). The model configuration platform 110 can be: a computer system, a network of computer systems, a set of processing systems (e.g., processors, ASICs, etc.), or otherwise configured.

The neural network model 105 functions as a representation of a neural network. In some embodiments, the neural network model 105 is a model of a neural network (for which a configuration is to be determined) that is stored or implemented on the same computer device as the model configuration platform 110, while in other embodiments the neural network model 105, hardware platform 102, and model configuration platform 110 are all components of separate computer devices. In some embodiments, the neural network model 105 can represent one of a plurality of candidate models stored by the system. Any combination of components and computer devices may be contemplated.

In some embodiments, the neural network model 105 may represent a deep learning neural network or set of neural networks, non-deep learning neural network(s), or a combination of deep learning and non-deep learning neural networks. In some embodiments, the neural network model 105 is capable of performing or executing tasks related to machine learning and/or deep learning techniques.

In some embodiments, the neural network model 105 can be a graph (e.g., a directed acyclic graph), wherein each graph node can represent a layer and each edge can represent a tensor (e.g., input/output tensor). However, the neural network model 105 can be otherwise represented for analysis. Each node and/or edge can be associated with one or more layer or tensor: identifiers, constraints, requirements, variables that need values, or any other suitable information. The neural network model 105 can be automatically generated (e.g., from neural network code, such as Python, TensorFlow, Keras, and so on), manually generated, or otherwise generated.

The hardware platform 102 can be a computing system, network, or other hardware embodiment that is targeted for a possible hosting or implementation of the neural network model 105. The hardware platform 102 can be associated with hardware platform data (e.g., stored in a hardware characterization database), which can be sent to the model configuration platform 110. The hardware platform data can include one or more constraints of the hardware platform (e.g., constraints on the configuration variables, such as the maximum or required tensor size, the number of parallel tasks that can be performed, the memory availability, etc.).

The traversal module 120 operates to traverse the neural network model 105 to identify one or more decision points. In some embodiments, each of the decision points include at least one variable (configuration variable) requiring a valid value. In some embodiments, the traversal module 120 identifies the decision points by identifying at least one of the variables and determining a choice, option, decision path, branching point, and/or potential modification of the variable. In some embodiments, traversing the neural network model includes stepping through each of the steps in the neural network model one by one in order. In some cases, traversal includes testing or evaluating one or more boundaries or edge cases of the steps in the neural network model. In some embodiments, traversing the neural network model includes stepping through the neural network model (e.g., graph), identifying the variables for each layer (node), identifying the variables for each tensor (edge), and determining constraints between the layers and/or tensors (e.g., the tensors for preceding and successive layers must match).

Examples of decision points in the neural network module may include:
a. tensor10_layout=LayoutChoice (NCHW, NHWC, . . . )
b. conv3_alg=ConvAlgChoice (GEMM, PRECOMP_GEMM, FFT, WINOGRAD, . . . )
c. tensor10_shape0=3

Constraints module 130 operates to identify one or more constraints for adapting the neural network model 105 to the hardware platform 102. In some embodiments, the constraints module 130 identifies one or more variable constraints specified by the hardware platform for the neural network model, specific to the variable being implemented on the hardware platform. In some embodiments, the constraints module 130 identifies one or more model constraints specified by the hardware platform for the neural network model, specific to the neural network model being implemented on the hardware platform. Example hardware constraints may relate to a processing resource of the hardware platform, such as memory size, cache size, processor information (e.g., speed), instructions capable of being implemented, and so on. In some embodiments, the constraints module 130 identifies one or more performance constraints specified by the hardware platform for operating the neural network model on the hardware platform, including any constraints required by one or more low-level processors of the hardware platform.

For example, constraints among variables that are imposed by the hardware platform may include such constraints as:
a. Variable constraint: require ((conv3_alg==GEMM)-> (conv3_hardware==CudaCores))
b. Model constraint: require ((conv3_hardware==TensorCores) (tensor 10_shape0% 8==0))
c. Model constraint: require (tensor10_layout==tensor12_layout)
d. Performance constraint for running on Tensor Cores: require (conv3_hardware ==

TensorCores)

Additionally or alternatively, the constraints module 130 can specify software constraints (e.g., imposed by the operating system, etc.), use-case constraints, or any other suitable constraints. Constraints can include: a specific set of variable values that can be used (e.g., for a given piece of software, use case, etc.), variable relationships, or any other suitable set of constraints. The constraints can be determined: from a standards guide, from an API (e.g., for the software, hardware, etc.), received from a user (e.g., manually specified), obtained via automated performance of an internet or web-based, search, or otherwise determined.

The constraint satisfaction solver 140 operates to execute a constraint satisfaction method to determine values for the configuration variables (e.g., decision points). The constraint satisfaction solver is preferably an SMT solver that executes a satisfiability modulo theories (SMT) solving method for the neural network model, with the one or more identified constraints (including, e.g., variable constraints, model constraints, and/or performance constraints) and variable value options being fed into or ingested by the SMT solver 140 as inputs. In some embodiments, other suitable solvers may be used and fall within the scope of the disclosure herein. The variable value options can be: all values available for the given variable (e.g., all algorithm options for a given layer, all data types for a given data format, etc.); only values permitted by the constraints (e.g., only tensor lengths available for the given piece of hardware, such that the neural network may fit in memory); or be any other suitable set of value options. The variable value options can be: retrieved from a global database, retrieved from a database for the hardware or software, received from a user, or otherwise determined. In some embodiments, the SMT solver analyzes the configuration variables at the decision points, the available value options for each of the configuration variables, and the constraints (e.g., to the variables, model, and performance). The SMT solver then finds an assignment value for each the configuration variables that satisfies all of the constraints. In variants, the set of valid configuration variable values can be considered a “configuration” for the neural network. If constructed correctly, the result is a valid working configuration of the neural network model adapted to operate on the hardware platform. In some embodiments, the SMT solver provides the variable values to one or more operators or administrators of the model configuration platform 110, neural network model 105 and/or hardware platform 102, and the operators or administrators can manually or semi-manually declare variables from within the network, software, or hardware configuration. In some embodiments, the variables can be a specific format such as enumerations (e.g., one of four different values), integers, and more. In some embodiments, a list of variables is generated, and constraints between the variables are added to the list, and the list is ingested by the SMT solver.

In some embodiments, the variables are analyzed in terms of data layouts for one or more tensors that can include many values. In some embodiments, such tensors are not assigned variable values manually. In some embodiments, if a tensor is encountered by the SMT solver, the SMT solver includes a numerical value for the tensor, such as an integer in order for the tensor to be cache-compatible or cache-resident, or compatible with other elements.

In some embodiments, the SMT solver outputs a candidate configuration. If the candidate configuration is satisfiable (e.g., as determined by the configurations module 160), then the candidate configuration can be considered (e.g., labeled) a valid configuration, and stored for further analysis. In this variation, a new constraint, excluding the valid configuration can be added, and the SMT solver can be re-run with the new constraint. This can enable the system and method to successively generate multiple valid configurations for further analysis. In this variation, running successive solver instances on the problem (e.g., combination of constraint variables, value options, and constraints) can be halted when: no valid configurations are output (e.g., the problem is unsatisfiable), a predetermined number of valid configurations are generated, the valid configurations satisfy a performance metric (e.g., evaluation time, power consumption, memory consumption, etc. falls below a threshold value, etc.), or when any other suitable condition is satisfied. For example, when the SMT solver outputs a valid configuration, the system then adds the configuration to the set of constraints in a negated sense. The SMT solver method is then run again, and another valid configuration is generated from the negated valid configuration. Alternatively or additionally, multiple solver instances can be concurrently run on the problem, wherein valid configurations output by the instances can be subsequently compared and analyzed.

In some embodiments, the neural network model includes a number of convolutional algorithms that can be chosen. For example, for libraries such as cuDNN, certain algorithms may imply certain layouts or decisions. When one element or parameter is modified, an invalid configuration may result. If the SMT solver produces a layout for a tensor, then the SMT solver ensures that all variables within the configuration are compatible with the layout throughout the entire network.

The datastore 150 of the system may include one or more databases in which neural network data, hardware platform data, constraints, valid configurations, target performance metrics, configurations that satisfy one or more of the target performance metrics, neural network variables, and other pieces of data can be stored. The data can be: determined by the system (e.g., calculated, learned, etc. from data retrieved, received, or otherwise collected from, e.g., the neural network model 105 and/or the hardware platform 102), received from a user, operator or administrator, retrieved from an external database or remote network or computing system, or otherwise determined. In some embodiments, the datastore also stores output from the SMT solver, including analysis results and configuration information. Other various data or entities may be stored.

The configurations module 160 operates to receive one or more candidate configurations from the SMT solver, and, for each of the received candidate configurations, determine that the candidate configuration is satisfiable (e.g., all configuration variables have a value that satisfies all constraints; that all variables within every decision point are compatible within the neural network model and when operating on the hardware platform; etc.). In some embodiments, the configurations module 150 records the candidate configuration as valid upon such a determination, and stores it in the database 150.

In some embodiments, if the candidate configuration is unsatisfiable, the analysis ends there. In some embodiments, the configurations module 160 optionally inspects data in an “unsat core” within the SMT solver for insight into the minimum set of constraints that couldn't be satisfied. In some embodiments, overconstraint is possible in terms of so many constraints being ingested by the SMT solver that no satisfactory working configuration is possible. In some embodiments, the SMT solver can be configured to provide the unsat core data for manual removal or tweaking.

The performance module 170 operates to determine a “good” configuration (e.g., fast, low power, efficient memory usage, etc.) from a number of received candidate configurations, where the “good” configuration satisfies all constraints, and satisfies one or more target performance metrics. The performance module 170 can use one or more of: one or more target performance metrics, a set of rules, a set of heuristics, and/or an automated empirical search for “good” configurations. In some embodiments, a decision tree is used for heuristics analysis and/or the empirical search in order to determine a potentially more optimal configuration. In one variation, the performance module 170 can run the neural network with each valid configuration on the platform (e.g., using a test set of data, such as images), gather and/or receive target performance metrics, and compare the target performance metrics for each valid configuration run to select a “good” configuration (e.g., configuration that has the shortest evaluation time, consumes the least amount of power, consumes the least amount of memory, generates the least amount of heat, is the most accurate and/or otherwise performant, etc.). However, the performance module 170 can select a valid configuration for deployment (from the set of valid configurations output by the SMT solver), in any other suitable manner.

In some embodiments, additional constraints are added automatically or manually to determine one or more matching configurations that are labeled as “good” configurations. For example, if the hardware platform 102 is an accelerator, additional constraints can be imposed such as requiring data to be 16-bit floating points. Adding more data points will, in many cases, reduce the number of valid configurations and lead to a smaller number of potentially more optimized configurations that satisfy all constraints. In some embodiments, a metric is used or determined for a configuration that satisfies one or more target performance metrics, such as shortest evaluation time of the neural network model (e.g., time frame for a solution), lowest amount of power used, memory optimization, throughput optimization, and more. In some embodiments, such metrics include a threshold for the metric that must be met in order for a valid configuration to be labeled as a configuration that satisfies one or more of the target performance metrics.

In some embodiments, metrics such as accuracy are orthogonal or secondary considerations in determining a configuration that satisfies one or more target performance metrics, while in other embodiments they may be primary considerations such that a threshold accuracy must be exceeded in order for a configuration that satisfies the target performance metrics to be determined.

In some embodiments, once a potentially more optimized configuration is determined, the value assignments for the variables that were determined to constitute a configuration that satisfies the target performance metrics are propagated to the neural network model for operation on the hardware platform 102 or other hardware platform.

In some embodiments, an example embodiment of the system 100 or model configuration platform 110 can include a script, such as a python script, that ingests the neural network model data, constructs an SMT solver, traverses the network, declares variables and constraints, executes the SMT solver, receives assignments to the variables from the SMT solver based on a configuration that satisfies one or more target performance metrics, and then propagates the assigned values for the variables back to the neural network model.

In some embodiments, analysis results, graph visualizations, and other output can be provided via an interactive graphical user interface (GUI) such as a dashboard for neural network model operators and/or administrators. The GUI may be presented by a user device or the system 100. For example, the system 100 may generate the GUI or the user device may present the GUI and receive information from the system 100 for inclusion in the GUI. In some embodiments, the GUI allows for interaction with layers and edges between layers, and a user may be able to add constraints and remove constraints. In some embodiments, an output includes a representation of the neural network model as a graph, such as a directed acyclic graph. For example, one or more candidate configurations may be presented in the GUI. User input, such as user input to update constraints and/or adjust a neural network, may cause triggering of the SMT solver. As an example, the SMT solver may determine an updated candidate configuration.

### Example Flowchart

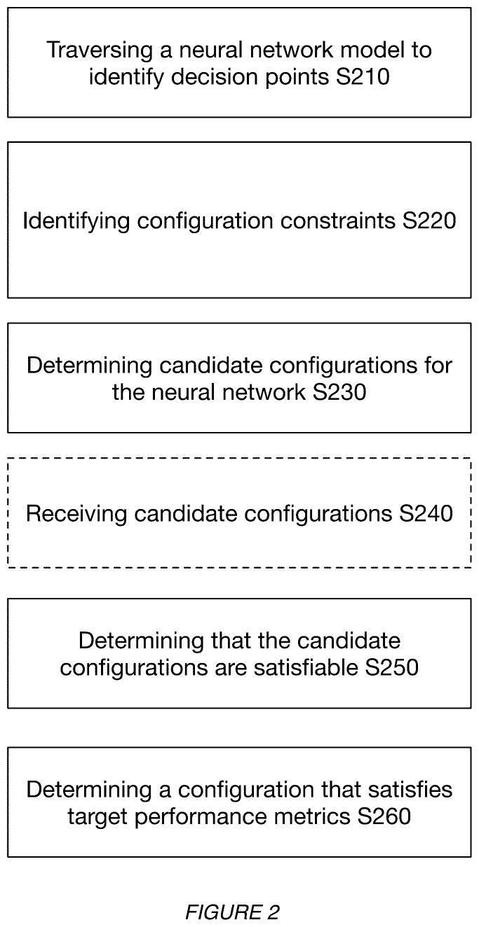

FIG. 2 is a flowchart representation of the object detection method.

S210 includes traversing a neural network model to identify decision points, as described above with respect to the traversal module 120.

S220 includes identifying variable constraints, model constraints and performance constraints, as described above with respect to the constraints module 130.

S230 includes executing an SMT solver for the neural network model, as described above with respect to the SMT solver 140.

The method can optionally include, S240, which includes receiving candidate configurations, as described above with respect to the configurations module 160.

S250 includes determining that the candidate configurations are satisfiable, as described above with respect to the configurations module 160.

S260 includes determining a configuration that satisfies one or more target performance metrics, as described above with respect to the performance module 170.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

### Additional Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A method comprising:
obtaining neural network model information in accordance with received input information, the received input information corresponding to a platform;
determining, by the one or more processors using the input information, constraints associated with adapting a neural network to the platform, the neural network generated from the neural network model information;
executing, by the one or more processors, a satisfiability solver on the constraints to generate a candidate configuration for the neural network; and
responsive to determining that the candidate configuration is valid, updating, by the one or more processors, the constraints by negating the candidate configuration to adapt the neural network to the platform.

2. The method of claim 1, wherein the neural network comprises a plurality of decision points that are associated with at least one of a layout of the neural network, of numerical precision, algorithm selection, data padding, accelerator use, or stride.

3. The method of claim 1, wherein the platform is at least one of a software platform or a hardware platform.

4. The method of claim 1, further comprising:
identifying, by the one or more processors, a plurality of configuration variables associated with the candidate configuration, each variable in the plurality of variables including a value;
determining, by the one or more processors, that the value of each configuration variable satisfies the constraints and one or more performance metrics; and
determining, by the one or more processors, that the candidate configuration is valid, in response to the value of each configuration variable satisfying the constraints and one or more performance metrics.

5. The method of claim 4, further comprising determining, by the one or more processors, that the candidate configuration is invalid, in response to the value of each configuration variable not satisfying the constraints and one or more performance metrics.

6. The method of claim 1, wherein executing the satisfiability solver further comprises:
feeding, by the one or more processors, the constraints to the satisfiability solver;
analyzing, by the one or more processor using the satisfiability solver, a plurality of variables based on a layout of the neural network; and
outputting, by the one or more processors using the satisfiability solver, the candidate configuration according to the analyzed plurality of variables and the constraints.

7. The method of claim 1, further comprising:
executing, by the one or more processors, the satisfiability solver on the updated constraints to generate a second candidate configuration for the neural network; and
updating, by the one or more processors, the constraints by negating the second candidate configuration to adapt the neural network to the platform, responsive to determining that the second candidate configuration is valid.

8. The method of claim 7, further comprising selecting, by the one or more processors, an output candidate configuration based on analyzing the candidate configuration and the second candidate configuration, wherein input data is provided to the candidate configuration and the second candidate configuration, and wherein the output candidate configuration is selected based on performance metrics associated with the candidate configuration and the second candidate configuration.

9. The method of claim 1, further comprising:
presenting, by the one or more processors via a user interface, a dashboard to display the candidate configuration; and
in response to a user input associated with updating the determined constraints, triggering, the satisfiability solver to determine an updated candidate configuration based on the user input.

10. The method of claim 1, wherein the neural network is a directed graph, wherein each node of the neural network corresponds to a layer and each edge connecting each node corresponds to a tensor.

11. A system comprising:
one or more processors coupled with memory and configured to:
obtain neural network model information in accordance with received input information, the received input information corresponding to a platform;
determine using the input information constraints associated with adapting a neural network to the platform, the neural network generated from the neural network model information;
execute a satisfiability solver on the constraints to generate a candidate configuration for the neural network; and
update the constraints by negating the candidate configuration to adapt the neural network to the platform, responsive to determining that the candidate configuration is valid.

12. The system of claim 11, wherein the neural network comprises a plurality of decision points that are associated with a layout of the neural network, of numerical precision, algorithm selection, data padding, accelerator use, or stride.

13. The system of claim 11, wherein the platform is at least one of a software platform or a hardware platform.

14. The system of claim 11, the one or more processors to:
identify a plurality of configuration variables associated with the candidate configuration, each variable in the plurality of variables including a value;
determine that the value of each configuration variable satisfies the constraints and one or more performance metrics; and
determine that the candidate configuration is valid, in response to the value of each configuration variable satisfying the constraints and one or more performance metrics.

15. The system of claim 14, the one or more processors to determine that the candidate configuration is invalid, in response to the value of each configuration variable not satisfying the constraints and one or more performance metrics.

16. The system of claim 11, wherein, when executing the satisfiability solver, the one or more processors to:
feed the constraints to the satisfiability solver;
analyze, using the satisfiability solver, a plurality of variables based on a layout of the neural network; and
output, using the satisfiability solver, the candidate configuration according to the analyzed plurality of variables and the constraints.

17. The system of claim 11, the one or more processors to:
execute the satisfiability solver on the updated constraints to generate a second candidate configuration for the neural network; and
update the constraints by negating the second candidate configuration to adapt the neural network to the platform, responsive to determining that the second candidate configuration is valid.

18. The system of claim 17, the one or more processors to:
select an output candidate configuration based on analyzing the candidate configuration and the second candidate configuration, wherein input data is provided to the candidate configuration and the second candidate configuration, and wherein the output candidate configuration is selected based on performance metrics associated with the candidate configuration and the second candidate configuration.

19. The system of claim 11, the one or more processors to:
presenting, by the one or more processors via a user interface, a dashboard to display the candidate configuration; and
in response to a user input associated with updating the determined constraints, triggering, the satisfiability solver to determine an updated candidate configuration based on the user input.

20. The system of claim 11, wherein the neural network is a directed graph, wherein each node of the neural network corresponds to a layer and each edge connecting each node corresponds to a tensor.
